(19) United States
(12) Patent Application Publication
(10) Pub. No.: US 2026/0152177 A1
(43) Pub. Date: Jun. 4, 2026

(54) Method and Device for the Automated Execution of a Lateral Control Maneuver

(71) Applicant: Bayerische Motoren Werke Aktiengesellschaft, Muenchen (DE)

(72) Inventors: Andreas LECHNER, Muenchen (DE); Patrick SAUERMANN, Augsburg (DE)

(21) Appl. No.: 19/125,348

(22) PCT Filed: Oct. 26, 2023
(86) PCT No.: PCT/EP2023/079972

§ 371 Date: Apr. 29, 2025

(30) Foreign Application Priority Data
Nov. 7, 2022 (DE) 10 2022 129 299.1

(51) Int. Cl. B60W 30/12; B60W 30/045; B60W 30/14; B60W 50/10; B60W 60/00

(52) U.S. Cl. CPC B60W 30/12; B60W 30/045; B60W 30/146; B60W 50/10; B60W 60/001; B60W 2552/30; B60W 2555/60; B60W 2720/10

(57) ABSTRACT

The invention relates to a device for carrying out a lateral guidance maneuver of a vehicle, in which at least the lateral guidance of the vehicle is effected in an automated manner. The device is configured to detect a maneuver speed and a threshold speed, which exceeds the maneuver speed, for carrying out the lateral guidance maneuver. The device is also configured to detect a speed request made by the driver of the vehicle for the longitudinal speed when carrying out the lateral guidance maneuver. Furthermore, the device is configured to adjust the longitudinal speed of the vehicle when carrying out the lateral guidance maneuver depending on the maneuver speed, the threshold speed and the speed request.

### BACKGROUND AND SUMMARY

The invention relates to a method and a corresponding device for the automated execution of a lateral control maneuver of a motor vehicle.

A vehicle can have an automated driving function which is designed to guide the vehicle longitudinally and/or transversely in an at least partially or fully automated manner. It may be advantageous to involve the driver of the vehicle in the operation of the automated driving function, in particular in order to increase the safety and/or comfort of the driving function.

This document deals with the technical task of enabling the driver of a vehicle to be involved in the longitudinal guidance of the vehicle, thereby increasing comfort and/or safety when performing an automated lateral control maneuver.

The task is addressed by each of the independent claims. Advantageous embodiments are described, inter alia, in the dependent claims. It should be noted that additional features of a patent claim dependent on an independent patent claim can form a separate invention independent of the combination of all features of the independent patent claim, without the features of the independent patent claim or only in combination with a subset of the features of the independent patent claim, which can be made the subject of an independent claim, a divisional application or a subsequent application. This applies in the same way to technical teachings described in the description, which can form an invention independent of the features of the independent patent claims.

According to one aspect, a device for performing a lateral control maneuver of a (motor) vehicle is described. When performing the lateral control maneuver, at least the lateral guidance of the vehicle can be effected automatically. Exemplary lateral control maneuvers are a drive through a curve, a drive into or out of a traffic circle, a turn onto another lane (e.g. at an intersection), etc.

The device is set up to determine a maneuvering speed and a limit speed in excess of the maneuvering speed for carrying out the lateral control maneuver. For this purpose, the radius of a curve that is traversed as part of the lateral control maneuver can be determined. The radius can, for example, be determined on the basis of sensor data from one or more of the vehicle's environment sensors. Alternatively or additionally, the radius can be determined on the basis of a digital map for the road network traveled by the vehicle. The limit speed can then be determined on the basis of the radius of the curve (e.g. taking into account a maximum permissible lateral acceleration of the vehicle). The limit speed can be the longitudinal speed at which the lateral control maneuver can (only just) be carried out safely.

The maneuvering speed can be determined as a function of the limiting speed, in particular in such a way that the maneuvering speed is 10% or more or 20% or more below the limiting speed. The maneuvering speed can be a longitudinal speed at which the lateral control maneuver can be performed comfortably.

The device is further arranged to determine a speed requirement, effected by the driver of the vehicle, for the longitudinal speed of the vehicle when performing the lateral control maneuver. The speed requirement can be determined, for example, on the basis of the actuation, in particular on the basis of the deflection, of a control element, in particular an accelerator pedal or a driving handle, of the vehicle. The driver can thus be enabled to make a request in relation to the longitudinal speed of the vehicle by actuating the control element.

Furthermore, the device is set up to adjust the longitudinal speed of the vehicle when performing the lateral control maneuver as a function of the maneuver speed, the limit speed and the speed request. By taking into account different speed variables when setting the longitudinal speed for a lateral control maneuver, the comfort and safety of the vehicle can be increased.

The longitudinal speed of the vehicle can be limited to the limit speed when performing the lateral control maneuver and/or the lateral control maneuver can be performed at the limit speed if the speed requirement exceeds the limit speed. The vehicle can thus be automatically guided longitudinally at the limit speed if the speed requirement exceeds the limit speed. In this way, a particularly comfortable and safe execution of the lateral control maneuver can be achieved.

Alternatively or additionally, the device can be set up to use the maneuvering speed as the longitudinal speed of the vehicle when performing the lateral control maneuver if, in particular as long as, the speed requirement is lower than the maneuvering speed. Automated longitudinal guidance of the vehicle at the maneuvering speed can thus be achieved if the speed requirement is below the maneuvering speed. In this way, a particularly comfortable and safe execution of the lateral control maneuver can be achieved.

Alternatively or additionally, the device can be set up to adjust the longitudinal speed of the vehicle in accordance with the speed requirement when performing the lateral control maneuver if the speed requirement is between the maneuver speed and the limit speed. This allows the driver to manually guide the vehicle longitudinally when the speed requirement is between the maneuver speed and the limit speed. In this way, a particularly comfortable and safe execution of the lateral control maneuver can be achieved.

Change the execution of the lateral control maneuver. It can be checked repeatedly during the lateral control maneuver whether the respective speed requirement is less than the maneuver speed, lies between the maneuver speed and the limit speed, or is greater than the limit speed. The longitudinal speed of the vehicle can then be set according to the above rules. In this way, a particularly comfortable and safe execution of the lateral control maneuver can be achieved.

The device can be set up to determine whether or not the driver has aborted the automated execution of the lateral control maneuver, in particular by actuating the control element for setting the speed requirement. For example, it can be determined that the driver has aborted the automated execution of the lateral control maneuver if the speed request exceeds the limit speed by at least one offset value (e.g. by 10% or more of the limit speed), and/or if the temporal gradient of the speed request (which changes with time) (i.e. the temporal gradient of the time course of the speed request) reaches or exceeds a gradient threshold value.

The longitudinal speed of the vehicle during the automated execution of the lateral control maneuver may be set (as described herein) depending on the maneuver speed, the limit speed, and the speed requirement when it is determined that the driver has not aborted the automated execution of the lateral control maneuver. On the other hand, the longitudinal and lateral guidance of the vehicle can be handed over to the driver (e.g. by issuing a message to the driver) if it is determined that the driver has aborted the automated execution of the lateral control maneuver. In this way, particularly safe operation of the vehicle can be achieved.

The device can be set up to recognize that the driver has released the automated execution of the lateral control maneuver, in particular the automated execution of a turning maneuver (at a priority point, such as at a junction), by actuating the control element to set the speed requirement. Actuating the control element can also trigger a speed request.

It is then possible to accelerate the vehicle (starting from a standstill) to a specific value of the longitudinal speed in order to perform the lateral control maneuver automatically. The specific value of the longitudinal speed of the vehicle can depend (as described in this document) on the maneuvering speed, the limit speed and the speed requirement. In this way, a particularly comfortable and safe automated turning maneuver can be achieved.

According to a further aspect, a (road) motor vehicle (in particular a passenger car or a truck or a bus or a motorcycle) is described, which comprises the device described in this document.

According to a further aspect, a method for performing a lateral control maneuver of a vehicle is described, wherein during the lateral control maneuver at least the lateral guidance of the vehicle is effected in an automated manner. The method comprises determining a maneuvering speed and a limit speed exceeding the maneuvering speed for performing the lateral control maneuver. The method further comprises determining a speed requirement for the longitudinal speed effected by the driver of the vehicle (via a control element) when performing the lateral control maneuver. In addition, the method comprises adjusting the longitudinal speed of the vehicle when performing the lateral control maneuver as a function of the maneuver speed, the limit speed and the speed requirement. According to a further aspect, a software (SW) program is described. The SW program may be arranged to be executed on a processor (e.g. on a control unit of a vehicle), and thereby to perform the method described in this document.

According to a further aspect, a storage medium is described. The storage medium may comprise a SW program arranged to be executed on a processor, and thereby to perform the method described in this document.

It should be noted that the methods, devices and systems described in this document may be used alone or in combination with other methods, devices and systems described in this document. Furthermore, any aspects of the methods, devices and systems described in this document can be combined with each other in a variety of ways. In particular, the features of the claims may be combined in a variety of ways. Furthermore, features listed in brackets are to be understood as optional features.

In the following, the invention is described in more detail with reference to examples of embodiments.

### BRIEF DESCRIPTION OF THE DRAWINGS

FIG. 1 shows exemplary components of a vehicle;

FIG. 2 shows an exemplary driving situation with a lateral control maneuver;

FIG. 3 shows an exemplary relationship between the speed requirement of a driver and the longitudinal speed of a vehicle; and

FIG. 4 is a flow chart of an exemplary procedure for controlling the longitudinal guidance of a vehicle as part of an automated lateral control maneuver.

### DETAILED DESCRIPTION OF THE DRAWINGS

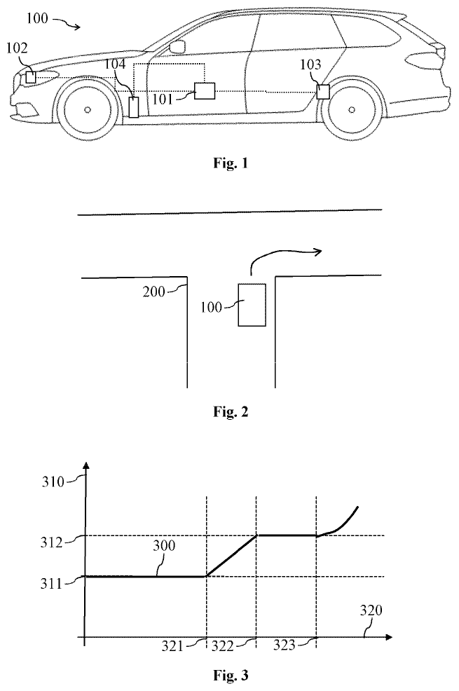

As stated at the outset, the present document is concerned with increasing the comfort and/or safety of an automated lateral control maneuver of a vehicle. In this context, FIG. 1 shows an exemplary vehicle 100 comprising one or more environment sensors 102, each of which is arranged to detect sensor data (i.e. environment data) relating to the environment of the vehicle 100. Exemplary environment sensors 102 are radar sensors, lidar sensors, cameras and/or ultrasonic sensors.

A (control) device 101 of the vehicle 100 is set up to create an environment model of the surroundings on the basis of the environment data. Furthermore, one or more longitudinal and/or lateral guidance actuators 103 can be operated as a function of the environment data and/or the environment model in order to provide an automated driving function for automated longitudinal and/or lateral guidance of the vehicle 100. Exemplary actuators 103 are a drive motor, a braking device and/or a steering device.

As part of the driving function, the longitudinal guidance and lateral guidance of the vehicle 100 can be effected automatically. It may be advantageous to involve the driver of the vehicle 100 in the vehicle guidance if necessary, for example to decide at an intersection whether the vehicle 100 can enter the intersection or not.

FIG. 2 shows an exemplary driving situation in which the vehicle 100 is at an intersection 200 with another roadway and wishes to turn onto the other roadway. The vehicle 100 may have been automatically guided (longitudinally and/or transversely) to the stop line at the junction 200 as part of the automated driving function. Furthermore, the vehicle 100 may have been automatically brought to a stop at the stop line. It is now the task of the driver to assess the traffic situation, in particular to check whether or not the vehicle 100 must give way to another road user at the intersection 200. If the driver recognizes that the intersection 200 is clear, the driver may actuate a control element 104 of the vehicle 100 to inform the vehicle 100 that the automated turning maneuver may be performed. In response to the actuation of the control element 104, the automated driving function may cause the automated turning maneuver to be performed by the vehicle 100. To this end, the vehicle 100 can be accelerated from a standstill to a certain maneuvering speed. Furthermore, the vehicle 100 can be steered automatically.

The control element 104 of the vehicle 100 may be configured to enable the driver of the vehicle 100 in manual ferry mode to accelerate the vehicle 100 and/or to determine the driving speed of the vehicle 100. The control element 104 may be, for example, an accelerator pedal or a driving handle. It may be sufficient for the driver to actuate the control element 104 relatively briefly (e.g., in a pulse-like manner) to cause the vehicle 100 to start from a standstill in order to perform an automated lateral control maneuver.

On the other hand, it may be advantageous to enable the driver of the vehicle 100 to influence the longitudinal speed of the vehicle 100 when performing an automated lateral control maneuver via the control element 104. In particular, the driver may be enabled to increase the longitudinal speed of the vehicle 100 by actuating the control element 104 beyond the maneuvering speed determined by the driving function in order to increase the comfort of the automated lateral control maneuver.

FIG. 3 shows an exemplary relationship 300 between the longitudinal speed 310 of the vehicle 100 and the driver's speed request 320 (effected via the control element 104) when performing an automated lateral control maneuver. As explained above, a maneuvering speed 311 for performing the automated lateral control maneuver may have been determined by the automated driving function. Furthermore, a limit speed 312 may have been determined by the driving function, which should not be exceeded when performing the automated lateral control maneuver. The maneuvering speed 311 and/or the limit speed 312 may depend on the curve radius r of the curve that is traversed as part of the automated lateral control maneuver. The maneuver speed 311 is typically less (e.g., 10% or more, or 20% or more less) than the limit speed 312.

The driver may (e.g., by deflecting the control element 104) make a speed request 320 (for longitudinal speed) to the vehicle 100. The speed request 320 may be taken into account according to a predefined context 300 when performing the automated lateral control maneuver. In particular, the longitudinal acceleration and/or the driving speed of the vehicle 100 may depend on the speed requirement 320 when performing the automated lateral control maneuver according to the predefined context 300.

The relationship 300 shown in FIG. 3 causes the maneuvering speed 311 to be used when performing the automated lateral control maneuver as long as the speed requirement 320 is less than or equal to the maneuvering speed 311 (i.e., up to the first requirement value 321 of the speed requirement 320). Between the first request value 321 and a second request value 322 of the speed request 320 that exceeds it, the longitudinal speed 310 may be adjusted according to the respective request value until (when the second request value 322 is reached) the limit speed 312 is reached. Thus, the driver may be enabled to change the longitudinal speed 310 of the vehicle 100 between the maneuvering speed 311 and the limit speed 312 by setting a corresponding speed request 320 when performing the automated lateral control maneuver. In this way, the comfort of the automated lateral control maneuver can be increased.

If the speed request 320 exceeds the second request value 322 (and the driver thus requests a longitudinal speed 310 in excess of the limit speed 312), the increased request 320 may be ignored if necessary, so that the longitudinal speed 310 remains limited to the limit speed 312. In this way, safe execution of the automated lateral control maneuver can be ensured.

In addition, the driver of the vehicle 100 may be enabled to abort execution of the automated lateral control maneuver. For example, it may be detected that the speed request 320 effected by the driver (via the control element 104) reaches or exceeds a third request value 323 (which is greater than the second request value 322). Alternatively or additionally, it may be recognized that the temporal gradient of the deflection of the control element 104 and/or the temporal gradient of the change in the speed request 320 reaches or exceeds a certain gradient threshold. In response, the automated lateral control maneuver can be aborted so that the longitudinal and lateral guidance of the vehicle is transferred to the driver. This transfer can be communicated to the driver via a user interface of the vehicle 100 (acoustically and/or visually and/or haptically). Furthermore, a (possibly smooth) transition from the automated longitudinal and/or lateral guidance to a manual longitudinal and/or lateral guidance of the vehicle 100 can be effected. As explained at the beginning, a driver assistance system can be used to effect lateral guidance through a bend at a specific longitudinal speed. In a turning situation, the driver can be involved in the right-of-way decision (e.g. by operating the accelerator pedal). Furthermore, the driver can be enabled to accelerate the vehicle 100 by pressing the accelerator pedal. If the speed is too high due to the driver's request, the vehicle may leave the road (e.g. if the lateral acceleration limit from ECE R79 is exceeded).

As described in this document, the automated driving function may use a comfort-oriented maneuvering speed 311 for negotiating a curve or for a turning maneuver, which does not fully utilize the permissible lateral acceleration potential of the vehicle 100. Actuation of the accelerator pedal by the driver (e.g. when confirming continued travel) could result in the limit speed 312 of the vehicle being exceeded due to the increase in speed that sets in. The limit speed 312 can be determined, for example, as ν=sqrt(a_{y}*r), i.e.

$$v = \sqrt[2]{{a}_{y} r} ,$$

where a_{y} is like ECE R79 can be max. 3.0 m/s², and where r can be the Radius of the Curve or Trajectory in a turning maneuver. Furthermore, the Operator sqrt( ) stands for the Square Root.

In order not to exceed the maximum permissible limit speed 312 despite accelerator pedal actuation and thus to ensure the availability of lateral guidance, the longitudinal speed 310 can be limited by limiting the driver's desired acceleration. The longitudinal speed 310 can be limited to a value 312 that leads to compliance with the maximum permissible lateral acceleration. The driver's request can be checked for plausibility and, if necessary, only limited if the accelerator pedal position is not evaluated as an abort request by the assistance system. One example scenario is a right turn situation with a stop sign. The vehicle 100 is at the stop line with the active longitudinal and lateral guidance assistance system and the driver confirms the continuation of the journey by pressing the accelerator pedal. In order to follow the planned turning path (e.g. radius r=15m), the system has determined a comfort cornering speed 311 (e.g. 20 km/h). After moving off, the system can accelerate automatically to this speed 311. However, the driver presses the pedal continuously and so strongly that this cornering speed 311 would be significantly exceeded, which could degrade lateral control during the turning process. The measures described in this document can be used to limit the acceleration desired by the driver in such a way that the cornering limit speed 312 (e.g. 23 km/h) is not exceeded.

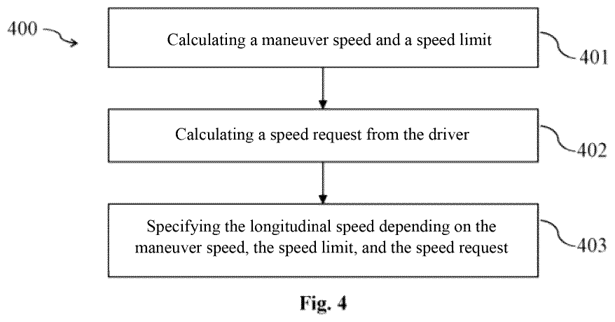

FIG. 4 shows a flowchart of a (possibly computer-implemented) method 400 for performing a lateral control maneuver of a vehicle 100, wherein in the lateral control maneuver at least the lateral guidance of the vehicle 100 is effected automatically. The lateral control maneuver may be, for example, a drive through a curve or a turning maneuver.

The method 400 comprises determining 401 a maneuvering speed 311 and a limit speed 312 in excess of the maneuvering speed 311 for performing the lateral control maneuver. The limit speed 312 can be determined, for example, as a function of the curve radius to be traveled as part of the lateral control maneuver. The maneuver speed 311 can be a certain value below the limit speed 312.

The method 400 further comprises determining 402 a speed requirement 320 for the longitudinal speed 310 effected by the driver of the vehicle 100 when performing the lateral control maneuver (e.g., based on the deflection of a control element 104, such as the accelerator pedal or the driving handle).

Further, the method 400 includes adjusting 403 the longitudinal speed 310 of the vehicle 100 when performing the lateral control maneuver based on the maneuvering speed 311, the limiting speed 312, and the speed requirement 320, wherein the longitudinal speed 310 may be automatically adjusted to the maneuvering speed 311 as long as the speed requirement 320 is less than the maneuvering speed 311. On the other hand, the longitudinal speed 310 can be limited to the limit speed 312 if the speed requirement 320 is greater than the limit speed 312. In these two cases, automated longitudinal guidance is thus provided.

On the other hand, the driver of the vehicle 100 may be enabled to (manually) adjust the longitudinal speed of the vehicle 100 by effecting appropriate speed requests 320 between the maneuvering speed 311 and the limit speed 312.

The measures described in the present document may increase the comfort and safety of a driving function for performing an automated lateral control maneuver.

The present invention is not limited to the embodiments shown. In particular, it should be noted that the description and the figures are only intended to illustrate the principle of the proposed methods, devices and systems by way of example.

1-11. (canceled)

12. A device for carrying out a transverse guidance maneuver of a vehicle, in which at least the lateral guidance of the vehicle is effected in an automated manner, wherein the device is configured to:
determine a maneuver speed and a limit speed, which goes beyond the maneuver speed, for carrying out the lateral guidance maneuver;
determine a speed request for a longitudinal speed caused by a driver of the vehicle during the execution of the lateral guidance maneuver; and
set the longitudinal speed of the vehicle during the execution of the transversal guidance maneuver as a function of the maneuver speed, the limiting speed and the speed requirement.

13. The device according to claim 12, wherein the device is configured to:
set the longitudinal speed of the vehicle to the limit speed when carrying out the transverse guidance maneuver; and
perform the transversal guidance maneuver when the speed request goes beyond the limit speed.

14. The device according to claim 12, wherein the device is configured to:
use the maneuver speed as a longitudinal speed of the vehicle when carrying out the transverse guidance maneuver when the speed request is smaller than the maneuver speed.

15. The device according to claim 12, wherein the device is configured to:
adjust the longitudinal speed of the vehicle when performing the lateral guidance maneuver according to the speed request when the speed request is between the maneuver speed and the limit speed.

16. The device according to claim 12, wherein the device is configured to:
determine the speed request on the basis of an actuation of a control element of the vehicle.

17. The device according to claim 12, wherein the device is configured to:
determine a radius of a curve that is traversed within the framework of the transverse guidance maneuver; and
determine the limit speed on the basis of the radius of the curve.

18. The device according to claim 12, wherein the device is configured to:
determine the maneuver speed as a function of the limit speed.

19. The device according to claim 12, wherein the device is configured to:
determine whether or not the driver has aborted the automated performance of the lateral guidance maneuver by actuating a control element for determining the speed-request;
adjust the longitudinal speed of the vehicle in the automated performance of the lateral guidance maneuver in dependence on the maneuver speed, the limiting speed, and the speed request when it is determined that the driver has not aborted the automated performance of the lateral guidance maneuver; and
transfer the longitudinal and lateral guidance of the vehicle to the driver when it is determined that the driver has aborted the automated performance of the lateral guidance maneuver.

20. The device according to claim 19, wherein the device is configured to determine that the driver has aborted the automated performance of the lateral guidance maneuver when at least one of:
the speed request exceeds the limit speed by at least one offset value; or
a temporal gradient of a change in the speed request reaches or exceeds a garage threshold value.

21. The device according to claim 12, wherein the device is configured to:
determine that the driver releases the automated performance of the lateral guidance maneuver of a turning maneuver at a pre-travel location by actuating a control element for determining the speed request.

22. A method for carrying out a transverse guidance maneuver of a vehicle, in which at least the lateral guidance of the vehicle is effected in an automated manner, the method comprising:
determining a maneuver speed and a limit speed, which goes beyond the maneuver speed, for carrying out the lateral guidance maneuver;
determining a speed request for a longitudinal speed caused by a driver of the vehicle during the execution of the lateral guidance maneuver; and
setting the longitudinal speed of the vehicle during the execution of the lateral guidance maneuver as a function of the maneuver speed, the limiting speed and the speed requirement.
